(19) United States
(12) Patent Application Publication
(10) Pub. No.: US 2009/0069983 A1
(43) Pub. Date: Mar. 12, 2009

(54) OCCUPANT RESTRAINT SYSTEMS FOR USE IN MILITARY LAND VEHICLES AND OTHER VEHICLES

(76) Inventors: Todd Humbert, Chandler, AZ (US); Ronald A. Shields, Mesa, AZ (US)

Correspondence Address: PERKINS COIE LLP;PATENT-SEA, P.O. BOX 1247, SEATTLE, WA, 98111-1247, US

(21) Appl. No.: 12/027,985

(22) Filed: Feb. 7, 2008

Related U.S. Application Data
(60) Provisional application No. 60/993,446, filed on Sep. 10, 2007.
(60) Provisional application No. 60/993,516, filed on Sep. 11, 2007.

(51) Int. Cl. G06F 19/00; B60R 22/02

(52) U.S. Cl. 701/45; 280/803; 280/806

(57) ABSTRACT

Occupant restraint systems for use in land vehicles and other vehicles are disclosed herein. A restraint system configured in accordance with an embodiment of the invention includes an elongate belt or web configured to extend across an occupant seated in a vehicle, such as a military land vehicle. A proximal end portion of the elongate web is operably coupled to a web retractor. The web retractor carries an electrically actuated web locking device operably coupled to an acceleration sensor. The acceleration sensor sends an electrical signal to the web locking device in response to vehicle acceleration in, for example, a vertical direction above a preset magnitude. The web locking device responds to the electrical signal by at least temporarily preventing the retractor from paying out web.

### CROSS-REFERENCE TO APPLICATIONS INCORPORATED BY REFERENCE

The following U.S. Provisional Patent Applications are incorporated into the present application in their entireties by reference: U.S. application Ser. No. 60/993,446, entitled “SINGLE POINT RELEASE SYSTEMS FOR MULTIPLE BUCKLE RESTRAINT SYSTEMS,” filed Sep. 10, 2007; and U.S. Application No. 60/993,516, entitled “SINGLE POINT RELEASE SYSTEMS FOR MULTIPLE BUCKLE RESTRAINT SYSTEMS,” filed Sep. 11, 2007.

### TECHNICAL FIELD

The following disclosure relates generally to occupant restraint systems for use in land vehicles, including military land vehicles.

### BACKGROUND

Some military ground vehicles use automotive-type, three-point seat belt systems with vehicle sensing locking devices. FIG. 1, for example, is an isometric view of a conventional seat belt retractor 150 having a vehicle sensing web locking device 100 (“web locking device 100”) configured in accordance with the prior art. The seat belt or “web” retractor 150 includes a base or mounting bracket 110 that is typically attached to a seat frame (not shown). A spool 160 is rotatably mounted to the bracket 110, and is fixedly coupled to a locking wheel 108. A seat belt or web 112 is drawn onto the spool 160 by a torque spring 152 when the web 112 is released from a corresponding buckle (also not shown). The web locking device 100 includes a steel ball 102 positioned in a cup 104. A locking arm 106 rests on top of the steel ball 102, and pivots about a pin 107 in response to movement of the ball 102.

In use, an occupant sitting in the seat extends the web 112 across a portion of their body, and releasably engages a tongue on the distal end of the web 112 with a corresponding buckle on the other side of the seat. During subsequent operation of the vehicle, if the vehicle strikes an object in the road or otherwise experiences a rapid deceleration while moving forward in direction F, the steel ball 102 will move forward in direction F. As the steel ball 102 moves forward, it pushes the locking arm 106 upwardly in direction L toward the locking wheel 108. As the locking arm 106 moves upwardly, it engages one of the teeth 109 on the locking wheel 108, thereby preventing the locking wheel 108 (and hence the spool 160) from rotating in direction R. As a result, the web 112 is held in place during the impact. Afterward, the steel ball 102 returns to its original position, and the locking arm 106 disengages from the locking wheel 108.

One shortcoming of the prior art web locking device 100 described above is that it may inadvertently “nuisance lock.” For example, the seat back may recline in such a way that the steel ball 102 pushes the locking arm 106 up against the locking wheel 108, inadvertently locking the spool 160. “Nuisance lock” can also occur during normal operation, including when the seat is not reclined. Nuisance lock can be particularly undesirable if the occupant desires to move about when the spool 160 is locked.

### BRIEF DESCRIPTION OF THE DRAWINGS

FIG. 1 is an isometric view of a web retractor having a vehicle sensing web locking device configured in accordance with the prior art.

FIGS. 2A-2C are front, right side, and left side views, respectively, of a vehicle occupant restraint system having a vertical axis web locking device configured in accordance with an embodiment of the invention.

FIGS. 3A and 3B are bottom isometric views illustrating a single-point web release system configured in accordance with an embodiment of the invention.

FIG. 4 is a rear isometric view of a vertical axis web locking system configured in accordance with an embodiment of the invention.

FIG. 5 is an enlarged, partially transparent isometric view of a web retractor having an electrically activated web locking device configured in accordance with an embodiment of the invention.

FIGS. 6A and 6B are enlarged, partially transparent side views of the web locking device of FIG. 5 in various stages of actuation.

FIG. 7 is a schematic diagram of the vertical axis web locking system of FIG. 4, configured in accordance with an embodiment of the invention.

### DETAILED DESCRIPTION

The following disclosure describes various embodiments of web locking devices for use with occupant restraint systems in various types of vehicles, including military ground vehicles and other land vehicles. For example, a web locking system configured in accordance with one embodiment of the invention includes a vertical acceleration sensor operably coupled to an electronically activated web locking device. The web locking device can include a solenoid-driven engagement feature that automatically locks a wheel on a web retractor when the vehicle experiences a vertical acceleration of sufficient magnitude.

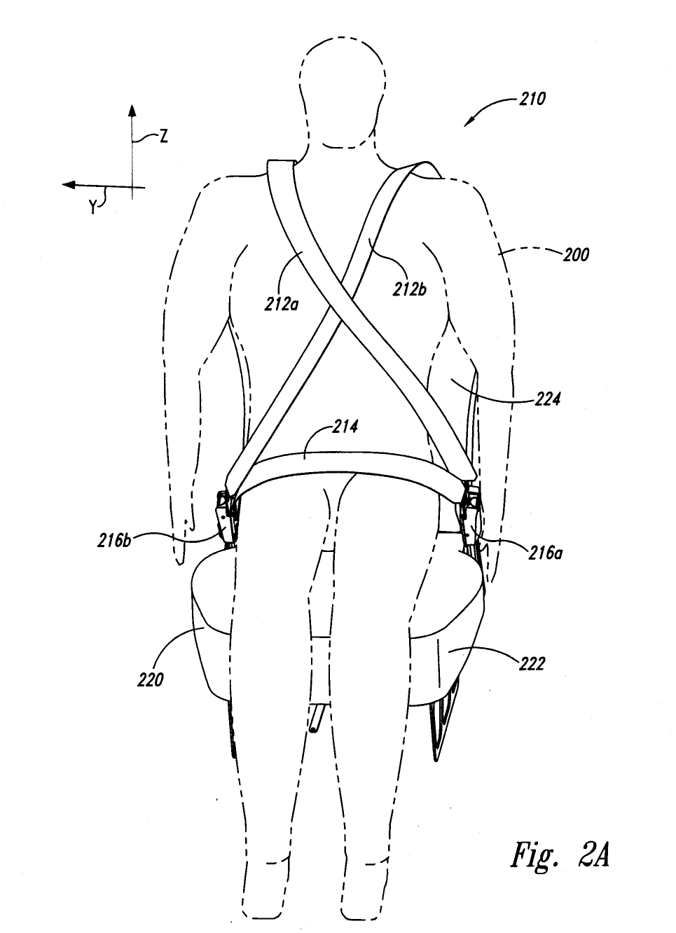

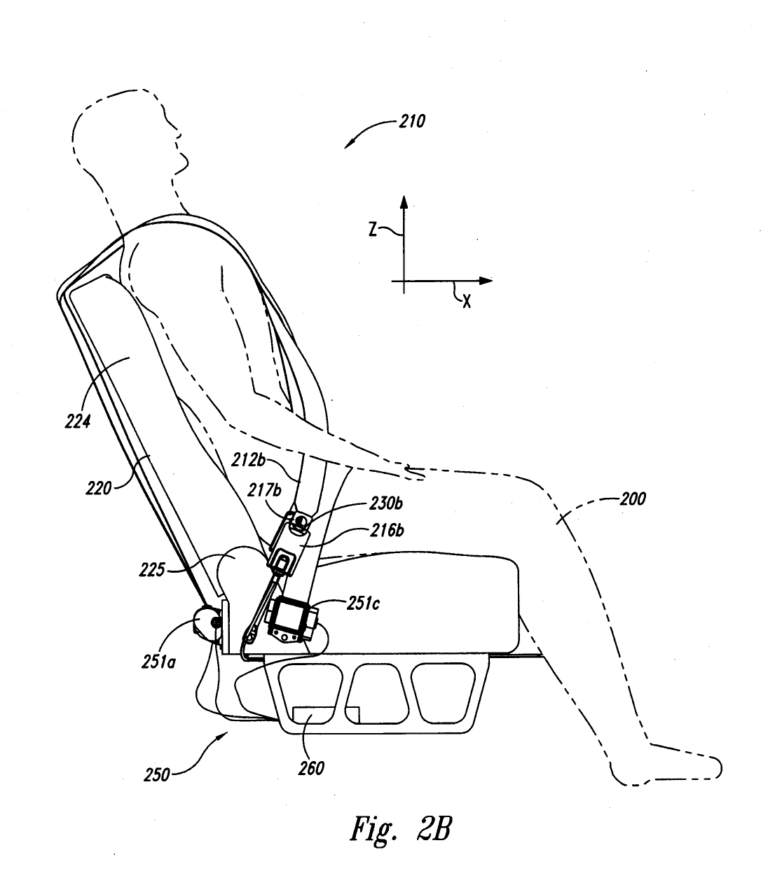

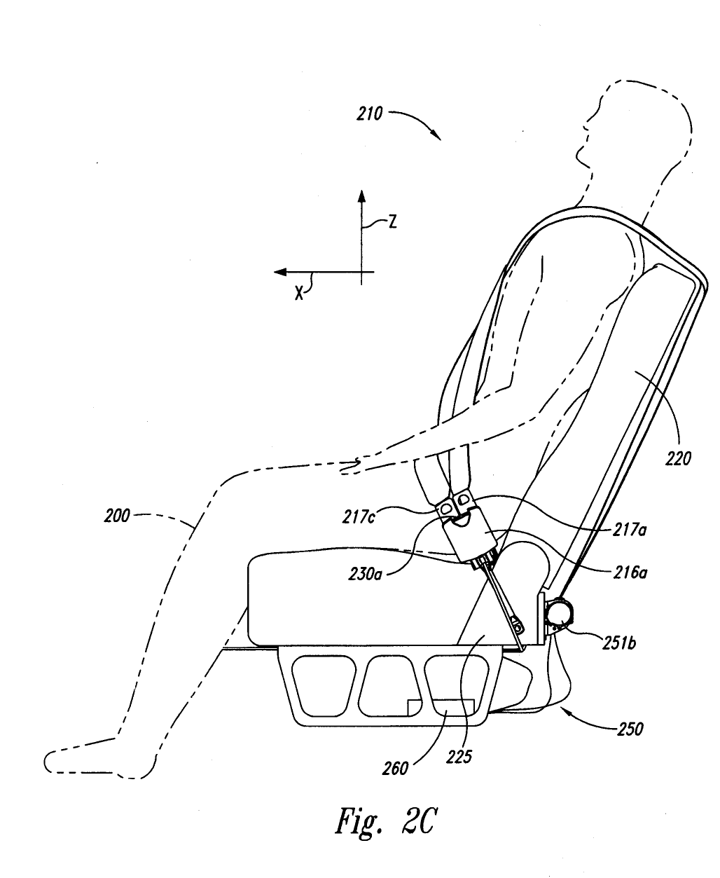

Certain details are set forth in the following description and in FIGS. 2-7 to provide a thorough understanding of various embodiments of the invention. Other details describing well-known structures and systems often associated with vehicle occupant restraint systems, web retractors and other related systems, however, have not been set forth in the following disclosure to avoid unnecessarily obscuring the description of the various embodiments of the invention.

Many of the details, dimensions, angles and other features shown in the Figures are merely illustrative of particular embodiments of the invention. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refer to the Figure in which that element is first introduced. For example, element 210 is first introduced and discussed with reference to FIG. 2.

FIGS. 2A, 2B and 2C are front, right side, and left side views, respectively, of an occupant restraint system 210 configured in accordance with an embodiment of the invention. In the illustrated embodiment, the occupant restraint system 210 (“restraint system 210”) secures an occupant 200 to a seat 220 during operation of a vehicle (not shown). Such vehicles can include, for example, military ground vehicles (e.g., High Mobility Multipurpose Wheeled Vehicles (“Humvees”) and other types of utility vehicles) as well as other types of military and non-military land, sea, and air vehicles. The seat 220 includes a base portion 222 and a back portion 224.

In one aspect of this embodiment illustrated in FIGS. 2B and 2C, the restraint system 210 includes a web locking subsystem 250 having a sensor assembly 260 operably coupled to a first web retractor 251a, a second web retractor 251b, and a third web retractor 251c. As described in greater detail below, in one embodiment the web locking subsystem 250 can automatically lock the web retractors 251 in response to vehicle acceleration in the vertical or Z direction above a predetermined magnitude.

Referring to FIGS. 2A-2C together, the restraint system 210 includes a first shoulder web 212a and a second shoulder web 212b which extend across the chest of the occupant 200. A proximal end portion of the first shoulder web 212a is operably coupled to the first web retractor 251a, and a proximal end portion of the second shoulder web 212b is operably coupled to the second web retractor 251b. In the illustrated embodiment, the first web retractor 251a and the second web retractor 251b are fixedly attached to a rear portion of a seat frame 225. The restraint system 210 also includes a lap belt or lap web 214 that extends across the lap of the occupant 200. A proximal end portion of the lap web 214 is operably coupled to the third web retractor 251c, which is fixedly attached to a right-side portion of the seat frame 225.

A distal end portion of the first shoulder web 212a includes a first tongue 217a that is releasably coupled to a first buckle 216a. The first buckle 216a is fixedly attached to a left-side portion of the seat frame 225. A distal end portion of the second shoulder web 212b includes a second tongue 217b that is releasably coupled to a second buckle 216b. The second buckle 216b is fixedly attached to a right-side portion of the seat frame 225. In the illustrated embodiment, the first buckle 216a includes dual latch mechanisms (not shown in detail). A first one of the dual latch mechanisms is configured to releasably engage the first tongue 217a of the first shoulder web 212a. An adjacent second one of the dual latch mechanisms is similarly configured to releasably engage a third tongue 217c which is attached to a distal end portion of the lap web 214.

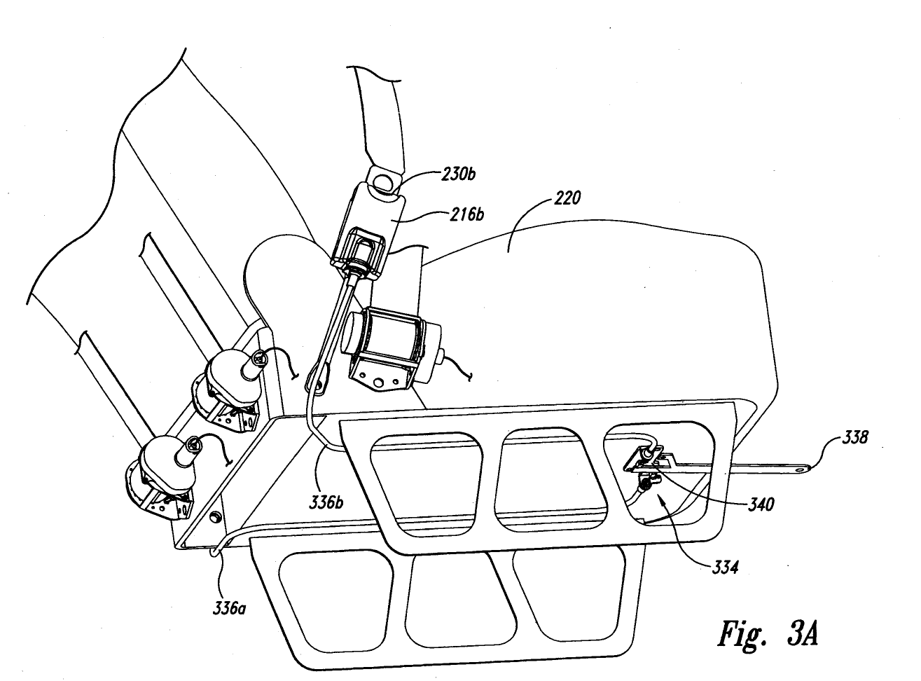

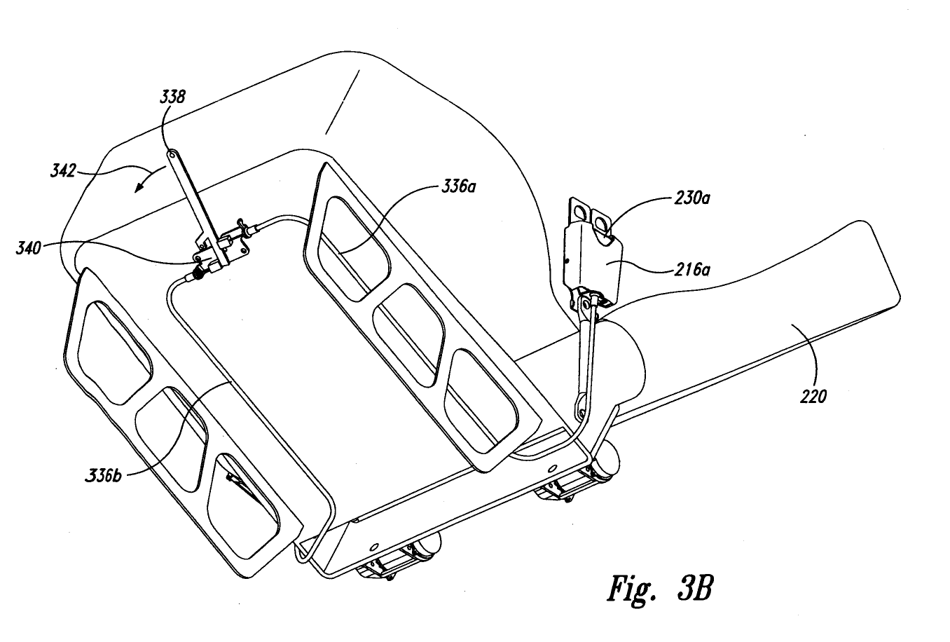

FIGS. 3A and 3B are bottom isometric views looking upwardly at the right side and left side portions, respectively, of the vehicle seat 220. Referring to FIGS. 3A and 3B together, in the illustrated embodiment the occupant restraint system 210 includes a single-point release system 334. The single-point release system 334 can be at least generally similar in structure and function to one or more of the single-point release systems described in detail in U.S. Provisional Patent Application No. 60/993,446, entitled “SINGLE POINT RELEASE SYSTEMS FOR MULTIPLE BUCKLE RESTRAINT SYSTEMS,” filed Sep. 10, 2007; and U.S. Provisional Patent Application No. 60/993,516, entitled “SINGLE POINT RELEASE SYSTEMS FOR MULTIPLE BUCKLE RESTRAINT SYSTEMS,” filed Sep. 11, 2007. (U.S. Provisional Patent Application Nos. 60/993,446 and 60/993,516 are incorporated herein in their entireties by reference.) For example, the single-point release system 334 can include a manual actuator 338 which is operably coupled to a cable release mechanism 340. A first cable 336a (e.g., a metallic cable slidably disposed in an outer jacket or casing) extends from the cable release mechanism 340 to the first buckle 216a. Similarly, a second cable 336b extends from the cable release mechanism 340 to the second buckle 216b.

When the occupant 200 wishes to simultaneously release the first shoulder web 212a and the lap web 214 from the first buckle 216a, and the second shoulder web 212b from the second buckle 216b (FIG. 2A), the occupant 200 can reach down and move the actuator 338 in a release direction 342 (FIG. 3B). Doing so simultaneously pulls on the first cable 336a and the second cable 336b, causing the latching mechanisms in the respective buckles 216 to simultaneously, or at least approximately simultaneously, release. This enables the occupant 200 to quickly exit the seat 220.

Although the single-point release system 334 can provide means for rapidly and/or simultaneously releasing the buckles 216, each of the buckles 216 can also include a corresponding release button 230 (identified individually as a first release button 230a and a release button 230b). The release buttons 230 can be individually depressed by the occupant 200 to individually release the respective buckles if the occupant 200 so desires.

As those of ordinary skill in the art will appreciate, the particular arrangement of shoulder and lap webs described above with reference to FIGS. 2A-2C, and the buckle release systems described above with reference to FIGS. 3A and 3B, represent only a few of the possible web and/or buckle configurations that can incorporate and benefit from the inventive aspects of the present invention. For example, in other embodiments, various aspects of the present invention can be utilized with occupant restraint systems having only a single shoulder web, as opposed to the cross-over dual shoulder web system described above. Furthermore, although a single-point buckle release system is described above with reference to FIGS. 3A and 3B, in other embodiments, various aspects of the occupant restraint system disclosed herein can be utilized with other types of single-point release systems, or with other types of buckle release systems that do not provide single-point release capability. Accordingly, the present invention is not limited to the particular web and/or buckle systems described above, but extends to other occupant restraint systems having web locking subsystems and devices as described below and as set forth in the following claims.

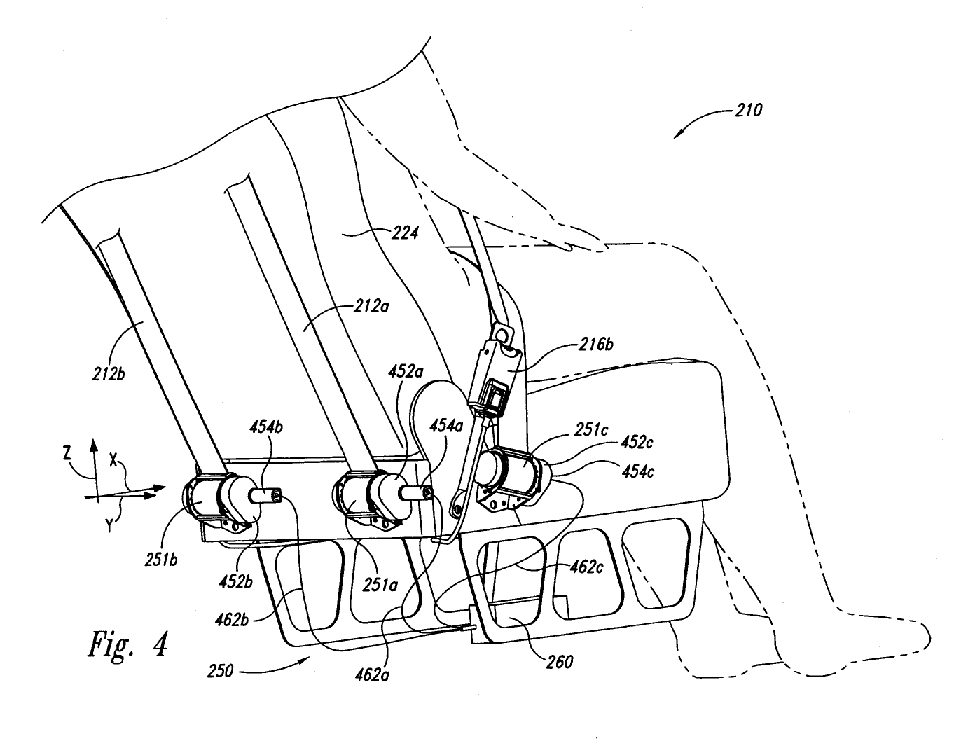

FIG. 4 is a rear isometric view of the occupant restraint system 210 illustrating various aspects of the web locking subsystem 250 in greater detail. In one aspect of this embodiment, the web locking subsystem 250 includes a plurality of electrically actuated locking devices 454 (identified individually as locking devices 454a-c). Each of the locking devices 454 is fixedly attached to a corresponding housing 452 on a corresponding web retractor 251. In addition, each of the locking devices 454 is electrically coupled to the sensor assembly 260 by means of a corresponding wired connection or link 462 (identified individually as links 462a -c).

As described in greater detail below, the sensor assembly 260 can include one or more acceleration sensors (e.g., accelerometers) configured to sense vehicle accelerations (and decelerations) in one or more directions and send associated control signals to the locking devices 454. For example, in one embodiment, the sensor assembly 260 can include at least one acceleration sensor configured to sense vehicle acceleration in the vertical direction along the Z axis. In other embodiments, however, the sensor assembly 260 can include one or more additional sensors configured to sense acceleration in the fore and aft directions along the X axis, and/or laterally along the Y axis.

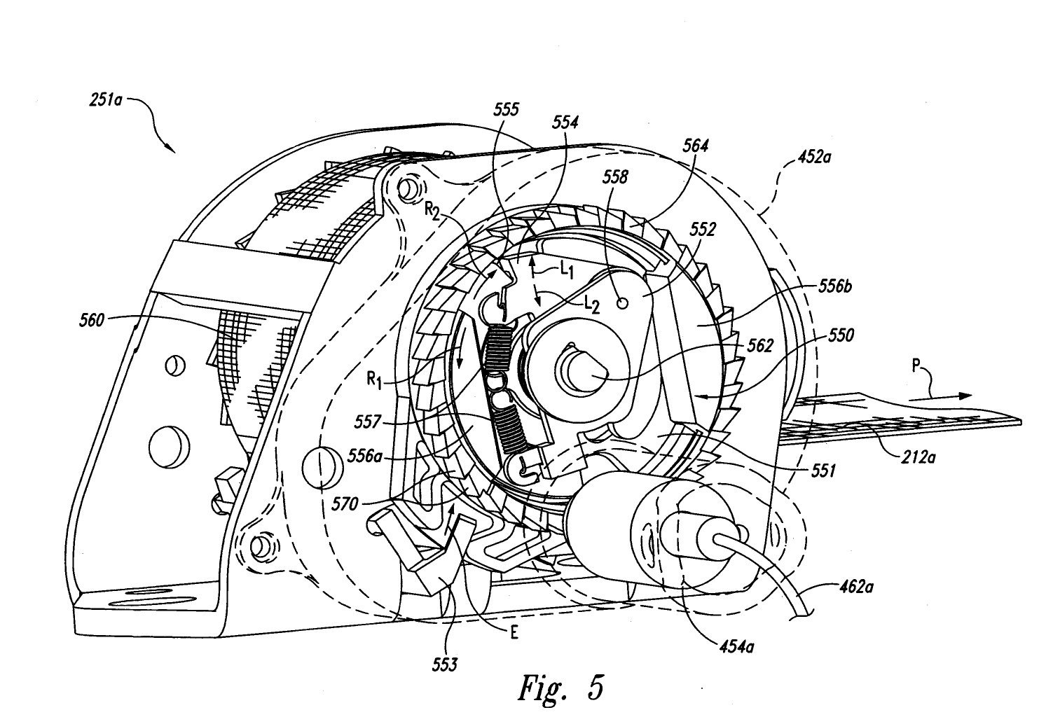

FIG. 5 is an enlarged, partially transparent isometric view of the first web retractor 251a. Although the first web retractor 251a is shown in FIG. 5, all of the web retractors 251a-c can be at least generally similar in structure and function. In one aspect of this embodiment, the web retractor 251a includes a spool 560 that receives the first shoulder web 212a. The spool 560 is fixedly attached to a rotating shaft 562. A distal end of the shaft 562 is fixedly coupled to a locking wheel 564 positioned under the housing 452a (shown transparently in FIG. 5). The locking wheel 564 includes a plurality of teeth 570 spaced about a perimeter thereof.

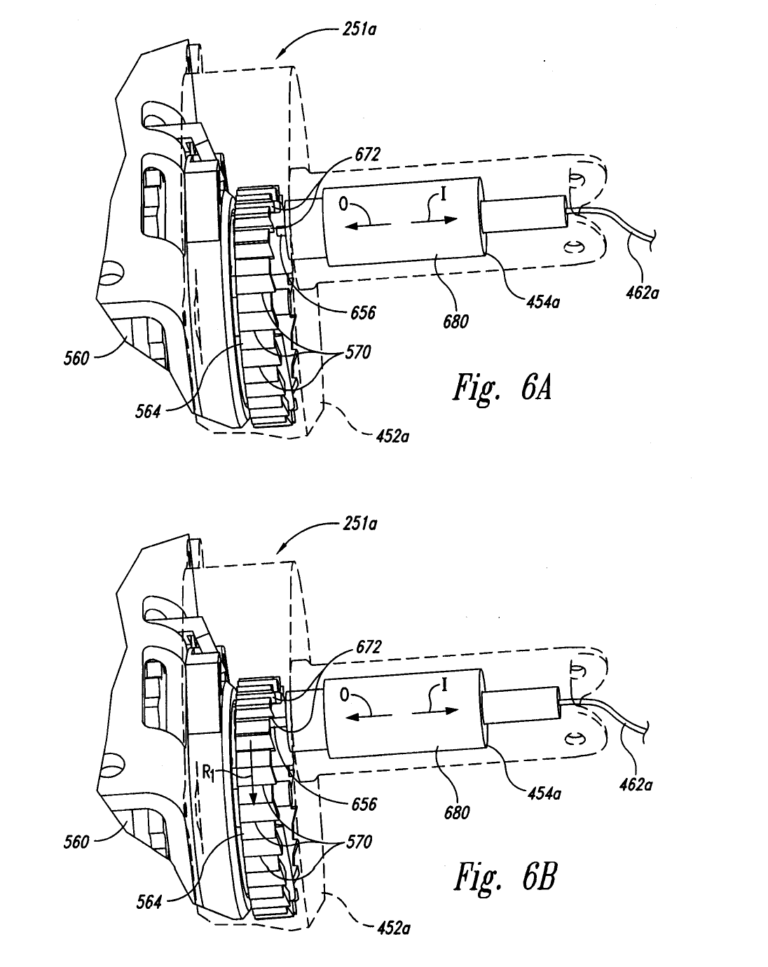

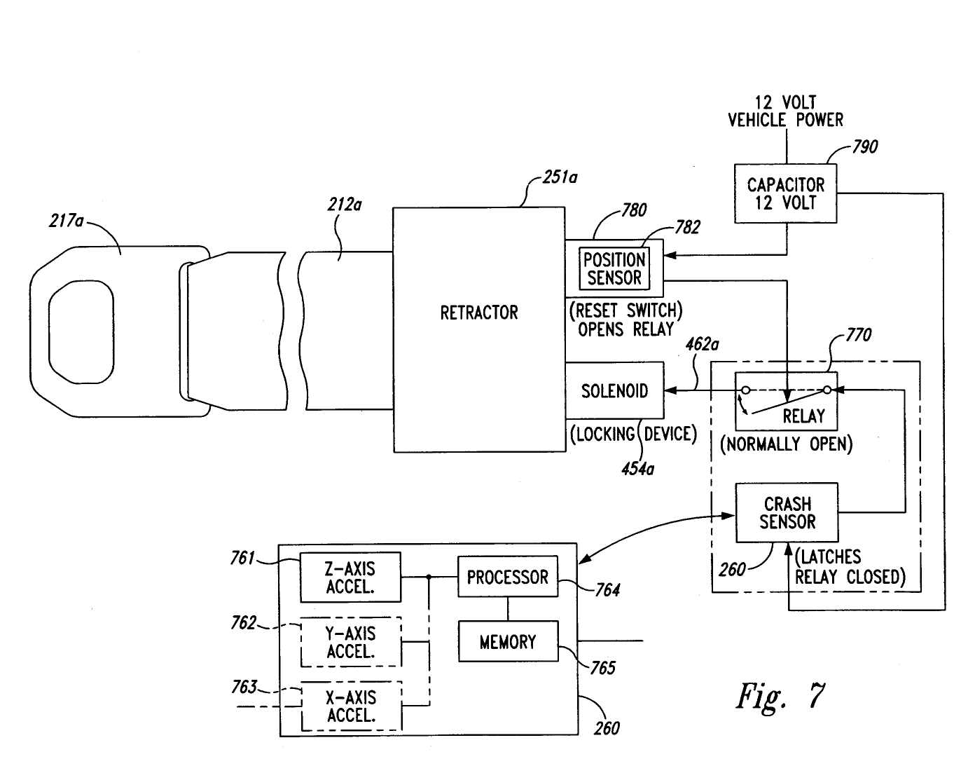

As described in greater detail below with reference to FIGS. 6A-7, when the sensor assembly 260 (FIG. 4) senses a vehicle acceleration above a preset magnitude in, e.g., the vertical direction Z, the sensor assembly 260 sends a corresponding electrical signal to the locking device 454a via the link 462a. The locking device 454a responds to the signal by engaging the teeth 570 on the locking wheel 564, thereby preventing the locking wheel 564 from rotating in direction R₁. This prevents the first shoulder web 212a from pulling away from the web retractor 251a in direction P during the acceleration event.

FIGS. 6A and 6B are enlarged, partially transparent side views illustrating the interaction between the locking device 454a and the locking wheel 564 in accordance with one embodiment of the invention. Referring first to FIG. 6A, at least a portion of the teeth 570 on the locking wheel 564 include raised or protruding faces 672 that extend outwardly toward the locking device 454a. The locking device 454a of the illustrated embodiment includes an engagement feature 656 that is driven by a solenoid 680. In the illustrated embodiment, the engagement feature 656 is a rod-like locking member that can move outwardly in direction O and inwardly in direction I relative to the locking device 454a. In other embodiments, the web locking subsystem 250 can include other types of electrically actuated locking devices having other types of engagement features.

In normal operating mode, the engagement feature 656 is retracted into the locking device 454a, as shown in FIG. 6A. In this position, the engagement feature 656 does not interfere with rotation of the locking wheel 564. When the sensor assembly 260 (FIG. 4) senses a vehicle acceleration above a predetermined magnitude in, for example, the vertical or Z direction, the sensor assembly 260 sends an electrical signal to the locking device 454a. The electrical signal energizes the solenoid 680, driving the engagement feature 656 outwardly toward the locking wheel 564. The extended engagement feature 656 engages one of the teeth 570 on the locking wheel 564, preventing the locking wheel 564 and the spool 560 from rotating in the R. direction. This also prevents the web 212a from extending further in the P direction (FIG. 5). As a result, the web 212a holds the vehicle occupant 200 (FIGS. 2A-2C) in the seat 220 during the vertical acceleration event. As described in greater detail below with reference to FIG. 7, after the event the sensor assembly 260 can disable or otherwise terminate the signal to the solenoid 680, causing it to retract the engagement feature 656 into the locking device 454a and disengage the locking wheel 564.

FIG. 7 is a schematic diagram of a portion of the web locking subsystem 250 described above with reference to FIGS. 2A-6B. During vehicle operation, a vehicle power circuit 790 provides power (e.g., 12-volt and/or 24-volt vehicle power) to the sensor assembly 260. In the illustrated embodiment, the sensor assembly 260 can include a Z-axis sensor 761 operably connected to a processor 764 and memory 765. In operation, the Z-axis sensor 761 can sense vehicle accelerations in the vertical or Z direction, and send corresponding information to the processor 764. The processor 764 can process the information in accordance with computer-readable instructions stored on the memory 765. More specifically, the processor 764 can determine if the Z-axis acceleration exceeds a preset magnitude and, if so, the processor 764 can send a corresponding signal to the locking device 454a via an activation circuit 770.

During normal vehicle operation, the activation circuit 770 disables the sensor assembly 260 and the locking device 454a. When the vehicle experiences a vertical acceleration of sufficient magnitude, the sensor assembly 260 activates the activation circuit 770 and transmits an electrical signal to the locking device 454a via the link 462a. As described above, the electrical signal causes the locking device 454a to at least temporarily lock the web retractor 251a and prevent further extension of the web 212a.

In the illustrated embodiment, the web retractor 251a remains locked for a preset time or until a reset switch 780 deactivates the activation circuit 770, de-energizing the locking device 454a. The reset switch 780 can include a position sensor 782 operably coupled to the web retractor 251 a. The position sensor 782 can include a contact or other suitable sensing device (not shown in detail) for sensing the presence of the tongue 217a on the distal end of the shoulder web 212a. When the tongue 217a is retracted back to the web retractor 251a, the reset switch 780 sends a corresponding signal to the activation circuit 770. The signal disables the activation circuit 770, de-energizing the locking device 454a so that the web 212a can again be pulled away from the web retractor 251a for use.

As those of ordinary skill in the art will appreciate, although the sensor assembly 260 of the illustrated embodiment senses and responds to vehicle accelerations in the vertical or Z direction, in other embodiments, the sensor assembly 260 can include additional sensors (e.g., accelerometers) to sense and respond to vehicle accelerations in other directions. For example, in another embodiment, the sensor assembly 260 can include a Y-axis sensor 762 and/or an X-axis sensor 763 for sensing and responding to vehicle accelerations in the left/right or Y direction and/or the fore/aft or X direction, respectively. In this other embodiment, the sensor assembly 260 can send signals to the respective locking devices 454 to lock the corresponding web retractors 251 when the vehicle experiences acceleration above a predetermined magnitude in the Y direction and/or the X direction.

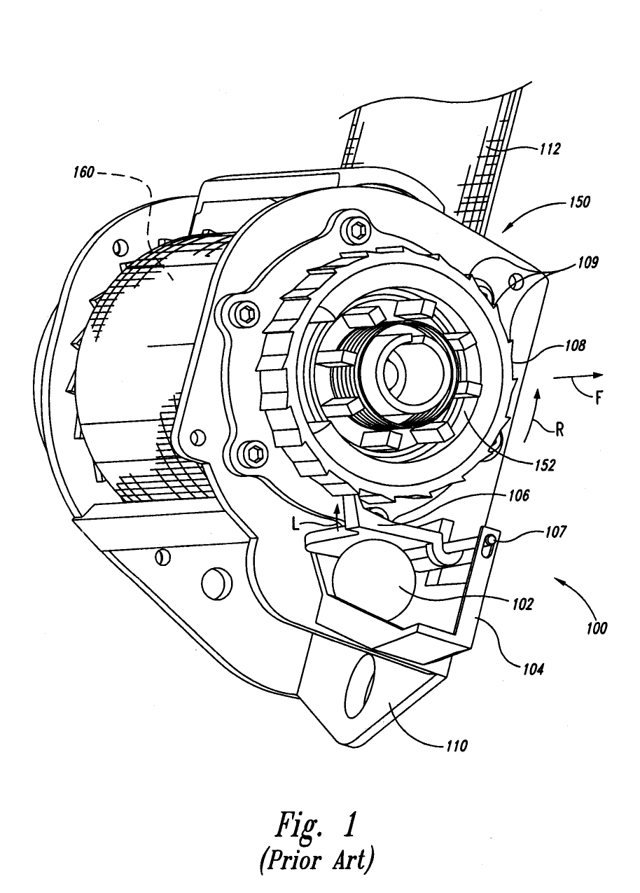

The web locking subsystem 250 described above can be referred to as a “vehicle sensing” system because it senses vehicle accelerations. In other embodiments, however, the occupant restraint system 210 can include other types of vehicle sensing web locking systems. Such systems can include, for example, a vehicle sensing web locking system that is at least generally similar in structure and function to the vehicle sensing web locking system 100 described above with reference to FIG. 1.

In addition, or alternatively, the web retractors 251 of the present invention can also include “web sensing” locking devices. For example, returning to FIG. 5, the web retractor 251a can include a web sensing locking mechanism 550 (“locking mechanism 550”). The locking mechanism 550 includes an offset plate 552 fixedly attached to the central shaft 562. A locking arm 554 is pivotably coupled to the offset plate 552 by a pin 558, and is biased inwardly toward the shaft 562 by one or more springs 557. The locking mechanism 550 further includes a backing plate 551 that is rotatably coupled to the shaft 562. The backing plate 551 carries counterweights 556.

When the web 212a is pulled from the spool 560, the central shaft 562 rotates in direction R₁. Rotation of the shaft 562 in direction R, drives the locking arm 554 in direction R₁ against an angled surface 555 on the backing plate 551. If the web 212a is pulled at a relatively low rate (as it would be, for example, when being “put on” by the vehicle occupant 200), the counterweights 556 on the backing plate 551 do not resist the rotation of the locking arm 554 so that the backing plate 551 and locking arm 554 rotate together. This permits the spool 560 to rotate freely in direction R₁.

Conversely, if the web 212a is extracted from the spool 560 at a higher rate (as it would be, for example, when the vehicle experiences a sudden impact that jolts the occupant 200) the counterweights 556 on the backing plate 551 resist the instantaneous push from the locking arm 554. As a result, the backing plate 551 hesitates slightly as the central shaft 562 rotates the locking arm 554 in direction R₁. This hesitation causes the locking arm 554 to slide outwardly on the angled surface 555 of the backing plate 551 in direction L₁. The locking arm 554 is operably coupled to a pawl 553. The outward motion of the locking arm 554 causes the pawl 553 to move inwardly in direction E and engage the teeth 570 of the locking wheel 564. The pawl 553 holds the locking wheel 564 and prevents the web 212a from being pulled from the spool 560. When the tension on the web 212a is released, a torque spring (not shown) drives the central shaft 562 in direction R₂. This allows the locking arm 554 to move inwardly toward the central shaft 562 in direction L₂. As the locking arm 554 moves inwardly, it disengages the pawl 553 from the locking wheel 564.

One advantage of the occupant restraint system 210 described above is that it can secure the occupant 200 in the seat 220 when the vehicle experiences a rapid acceleration or impact in the vertical or Z direction. A further advantage of the web locking subsystem 250 described above is that it can be combined with other vehicle sensing and web sensing web locking systems (such as the web sensing locking mechanism 550) to provide redundant systems for securing the vehicle occupant 200 during a vertical acceleration event. Yet another advantage of the web locking subsystem 250 is that it is not susceptible to the type of “nuisance locks” that may be experienced with conventional web locking systems that utilize a steel ball/cup arrangement, such as that described above with reference to FIG. 1.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. An occupant restraint system for use in a vehicle, the occupant restraint system comprising:
a flexible and elongate web configured to extend across at least a portion of an occupant seated in the vehicle;
a web retractor operably coupled to a proximal end portion of the web, wherein the web retractor is configured to automatically retract the web when a distal end portion of the web is released from a corresponding buckle;
an electrically actuated locking device operably coupled to the web retractor; and
an acceleration sensor operably coupled to the electrically actuated locking device, wherein the acceleration sensor is configured to send an electrical signal to the electrically actuated locking device in response to a vehicle acceleration above a predetermined magnitude, and wherein the electrically actuated locking device is configured to at least temporarily prevent the web from moving outwardly from the web retractor in response to receiving the electrical signal from the acceleration sensor.

2. The occupant restraint system of claim 1 wherein the acceleration sensor is configured to send the electrical signal to the electrically actuated locking device in response to a vehicle acceleration in the vertical direction.

3. The occupant restraint system of claim 1 wherein the vehicle is configured to move over land in a first direction, and wherein the acceleration sensor is configured to send the electrical signal to the electrically actuated locking device in response to a vehicle acceleration in a second direction, at least approximately perpendicular to the first direction.

4. The occupant restraint system of claim 1 wherein the acceleration sensor includes an accelerometer configured to send the electrical signal to the electrically actuated locking device in response to sensing a vehicle acceleration in the vertical direction, and wherein the electrically actuated locking device includes a solenoid locking device configured to prevent the web from moving outwardly from the web retractor in response to receiving the electrical signal from the accelerometer.

5. The occupant restraint system of claim 1 wherein the web retractor includes a rotatable spool operably coupled to the web, and wherein the electrically actuated locking device includes a solenoid-actuated engagement feature configured to releasably lock the spool in response to receiving the electrical signal from the accelerometer.

6. The occupant restraint system of claim 1 wherein the web is a first web, the web retractor is a first web retractor, and the electrically actuated locking device is a first electrically actuated locking device, and wherein the occupant restraint system further comprises:
a second flexible and elongate web configured to extend across at least a portion of the occupant;
a second web retractor operably coupled to a proximal end portion of the second web; and
a second electrically actuated locking device operably coupled to the second web retractor, wherein the acceleration sensor is configured to send a first electrical signal to the first electrically actuated locking device and a second electrical signal to the second electrically actuated locking device in response to a vehicle acceleration above a predetermined magnitude, wherein the first electrically actuated locking device is configured to at least temporarily prevent the first web from moving outwardly from the first web retractor in response to receiving the first electrical signal from the acceleration sensor, and wherein the second electrically actuated locking device is configured to at least temporarily prevent the second web from moving outwardly from the second web retractor in response to receiving the second electrical signal from the acceleration sensor.

7. The occupant restraint system of claim 1 wherein the acceleration sensor is a first acceleration sensor and the electrical signal is a first electrical signal, wherein the first acceleration sensor is configured to send the first electrical signal to the electrically actuated locking device in response to a vehicle acceleration in a first direction, and wherein the occupant restraint system further comprises:
a second acceleration sensor, wherein the second acceleration sensor is configured to send a second electrical signal to the electrically actuated locking device in response to a vehicle acceleration in a second direction, perpendicular to the first direction, above a predetermined magnitude, and wherein the electrically actuated locking device is configured to at least temporarily prevent the web from moving outwardly from the web retractor in response to receiving the second electrical signal from the second acceleration sensor.

8. The occupant restraint system of claim 1 wherein the web retractor includes a rotatable spool operably coupled to the web, and wherein the occupant restraint system further comprises:
a web sensitive web locking system operably coupled to the web retractor, wherein the web sensitive web locking system is configured to at least temporarily lock the spool in response to spool rotation above a predetermined rate.

9. An occupant restraint system for use in a vehicle, the occupant restraint system comprising:
an elongate web configured to extend across at least a portion of an occupant seated in the vehicle;
a web retractor operably coupled to a proximal end portion of the web; and
an automatic web locking device operably coupled to the web retractor, wherein the automatic web locking device automatically prevents extension of the web relative to the web retractor in response to a vertical acceleration of the vehicle above a predetermined magnitude.

10. The occupant restraint system of claim 9 wherein the automatic web locking device includes a solenoid-driven engagement feature.

11. The occupant restraint system of claim 9 wherein the web retractor includes a spool operably coupled to the proximal end portion of the web, and wherein automatic web locking device includes a solenoid-driven engagement feature configured to releasably engage the spool.

12. The occupant restraint system of claim 9 wherein the automatic web locking device includes a solenoid-driven engagement feature, and wherein the occupant restraint system further comprises an acceleration sensor operably coupled to the solenoid-driven engagement feature, wherein the acceleration sensor is configured to generate an electrical signal that is transmitted to the solenoid-driven engagement feature in response to a vertical acceleration of the vehicle above a predetermined magnitude.

13. A system for restraining an occupant in a vehicle, the system comprising:
means for securing a distal end portion of a belt that extends across at least a portion of the occupant when the occupant is seated in the vehicle;
means for manually releasing the distal end portion of the belt from the means for securing when the occupant desires to exit the vehicle;
means for retracting the distal end portion of the belt away from the means for securing when the distal end portion of the belt is released from the means for securing; and
means for automatically preventing extension of the belt from the means for retracting when the vehicle accelerates in a vertical direction above a predetermined rate.

14. The system of claim 13 wherein the means for automatically preventing extension of the belt include a solenoid device that is operably coupled to the means for retracting.

15. The system of claim 13 wherein the means for automatically preventing extension of the belt include a solenoid device that is operably coupled to the means for retracting and an acceleration sensor operably coupled to the solenoid device.

16. The system of claim 13 wherein the means for securing a distal end portion of a belt include first means for securing a first distal end portion of a first belt, wherein the system further comprises second means for securing a second distal end portion of a second belt that extends across at least a portion of the occupant when the occupant is seated in the vehicle, and wherein the means for manually releasing the first distal end portion of the first belt include means for at least approximately simultaneously releasing the first distal end portion of the first belt from the first means for securing and the second end portion of the second belt from the second means for securing when the occupant desires to exit the vehicle.

17. A method for restraining an occupant in a vehicle with a web, wherein the web extends across at least a portion of the occupant, and wherein the web is operably coupled to a retractor, the method comprising:
sensing a vehicle acceleration above a predetermined magnitude;
in response to sensing the vehicle acceleration, sending an electrical signal to an electrically actuated locking device operably coupled to the retractor; and
automatically locking the retractor in response to the electrical signal.

18. The method of claim 17 wherein sensing a vehicle acceleration includes sensing a vehicle acceleration in a vertical direction.

19. The method of claim 17 wherein sending an electrical signal to an electrically actuated locking device includes sending an electrical signal to a solenoid operably coupled to the retractor.

20. The method of claim 17 wherein the web is operably wound about a retractor spool, wherein retractor spool is operably coupled to a locking wheel, and wherein automatically locking the retractor in response to the electrical signal includes automatically engaging the locking wheel with a solenoid-driven engagement feature.
